(19) United States
(12) Patent Application Publication
(10) Pub. No.: US 2020/0274359 A1
(43) Pub. Date: Aug. 27, 2020

(54) SERIES COMPENSATION DEVICE

(71) Applicant: SIEMENS AKTIENGESELLSCHAFT, MUENCHEN (DE)

(72) Inventors: PATRIK ERNST, MUEHLHAUSEN (DE); GEORG PILZ, POXDORF (DE); ANDREAS HASELBAUER, ERLANGEN (DE)

(21) Appl. No.: 16/643,661

(22) PCT Filed: Aug. 31, 2017
(86) PCT No.: PCT/EP2017/071843

§ 371 Date: Mar. 2, 2020

(51) Int. Cl. H02J 3/18; H02M 7/49

(52) U.S. Cl. CPC H02J 3/1814; H02M 2007/4835; H02M 7/49

(57) ABSTRACT

A series compensation device for an electrical energy transmission network includes a transformer. A primary winding of the transformer can be connected in series in a phase line of the energy transmission network. The series compensation device has a modular multilevel power converter which has a plurality of modules that form an electrical module series circuit. The modular multilevel power converter is connected to a secondary winding of the transformer. A series compensation method for an electrical energy transmission network is also provided.

The invention relates to a series compensation device for an electrical energy transmission network.

The transmission of alternating current over long distances is primarily limited by the impedance of transmission lines in the energy transmission network. Series compensation devices, based upon passive components such as, for example, capacitors or coils, are therefore employed in order to offset or increase a proportion of the line reactance. As a result, active power which is transmittable via the line is increased. This substantially increases the efficiency of AC transmission.

In series compensation, it is known, for example, for a capacitor to be connected in series with the transmission line (a fixed series capacitor (FSC) or thyristor controlled series capacitor (TCSC)). The series impedance of the line is reduced as a result. By the application of a reactance coil, the impedance of a line can also be increased. It is further conceivable to employ a “SSSC” (static synchronous series compensator) for this purpose. The above-mentioned solutions must be tailored to the respective application in force and, for each project, must therefore be adapted or modified to a substantial extent.

The object of the invention is the disclosure of a series compensation device and a series compensation method which can be employed in a flexible manner.

According to the invention, this object is fulfilled by a series compensation device and by a series compensation method according to the independent patent claims.

Advantageous forms of embodiment of the series compensation device are disclosed in the dependent patent claims.

A series compensation device for an electrical energy transmission network is disclosed, having a transformer, wherein a primary winding of the transformer can be connected (or is connected) in series in a phase line of the energy transmission network, and having a modular multi-level power converter, which comprises a plurality of modules which form an electrical module series circuit, wherein the modular multi-level power converter (on the AC voltage side) is connected to a secondary winding of the transformer. It is particularly advantageous that a modular multi-level power converter is connected to the secondary winding of the transformer. More specifically, an AC voltage terminal of the multi-level power converter is connected to the secondary winding of the transformer. By means of the modular multi-level converter, virtually any desired voltage characteristics or voltages can be generated and applied to the secondary winding of the transformer. The effective impedance of the phase line can thus be influenced to a wide extent, and load flux control can be executed in the phase line. It is further advantageous that, by the employment of a modular multi-level power converter, unwanted oscillations in the energy transmission network (“sub-synchronous resonances”) which might be caused, for example, by the use of series capacitors with a constant capacitance, are prevented. The option for the damping of such resonances or oscillations is an advantageous property of the series compensation device.

The series compensation device can be configured such that the modular multi-level power converter comprises three module series circuits, which constitute a delta-connected circuit.

The series compensation device can also be configured such that the modular multi-level power converter comprises six module series circuits, which constitute a (three-phase) bridge circuit.

The series compensation device can be configured such that the modules respectively comprise at least two electronic switching elements and one electrical module energy store. Modules of this type are also described as sub-modules of the modular multi-level power converter.

The series compensation device can also be configured such that the two electronic switching elements of the modules are arranged in a half-bridge circuit, or the modules respectively comprise the two electronic switching elements and two further electronic switching elements, wherein the two electronic switching elements and the two further electronic switching elements are arranged in a full-bridge circuit. Modules of this type are also described as full-bridge modules or as full-bridge sub-modules of the modular multi-level power converter.

The series compensation device can also be configured such that the modular multi-level power converter (on the DC voltage side) is connected to an energy store. A DC voltage terminal of the multi-level power converter is thus connected to the energy store. It is particularly advantageous that the energy store can supply electrical energy to the modular multi-level power converter. As a result, the modular multi-level power converter can inject not only reactive power, but also active power into the energy transmission network.

The series compensation device can also be configured such that the energy store comprises a plurality of mutually connected energy storage units. By the employment of a plurality of mutually connected energy storage units, the energy store can advantageously deliver high currents or high voltages, and can also be rated to a high electrical capacity.

The series compensation device can be configured such that the energy storage units are capacitors and/or batteries.

The series compensation device can also be configured such that the multi-level power converter is actuated by a control device such that the multi-level power converter generates a periodically temporally variable voltage. This periodically temporally variable voltage is transformed by the transformer (to constitute a transformed voltage). The transformed voltage is serially applied to (injected into) the phase line of the energy transmission network by means of the transformer. The multi-level power converter is advantageously capable, as required, of generating a wide variety of periodically temporally variable voltages. As a result, the series compensation device can be employed for a variety of different compensation functions. The series compensation device can also be adapted to a wide variety of circumstances, with no hardware modifications.

A series compensation method for an electrical energy transmission network is further disclosed, wherein
a periodically temporally variable voltage is generated by a modular multi-level power converter,
said voltage is applied to a secondary winding of a transformer,
the transformer transforms said voltage on a primary winding of the transformer (thus constituting a transformed voltage), and
by means of the primary winding, the transformed voltage is serially applied to (injected into) a phase line of the energy transmission network.

This method provides equivalent advantages to those described above with reference to the series compensation device.

The invention is described in greater detail hereinafter with reference to exemplary embodiments. Identical or identically-acting elements are identified by the same reference numbers. In the figures:

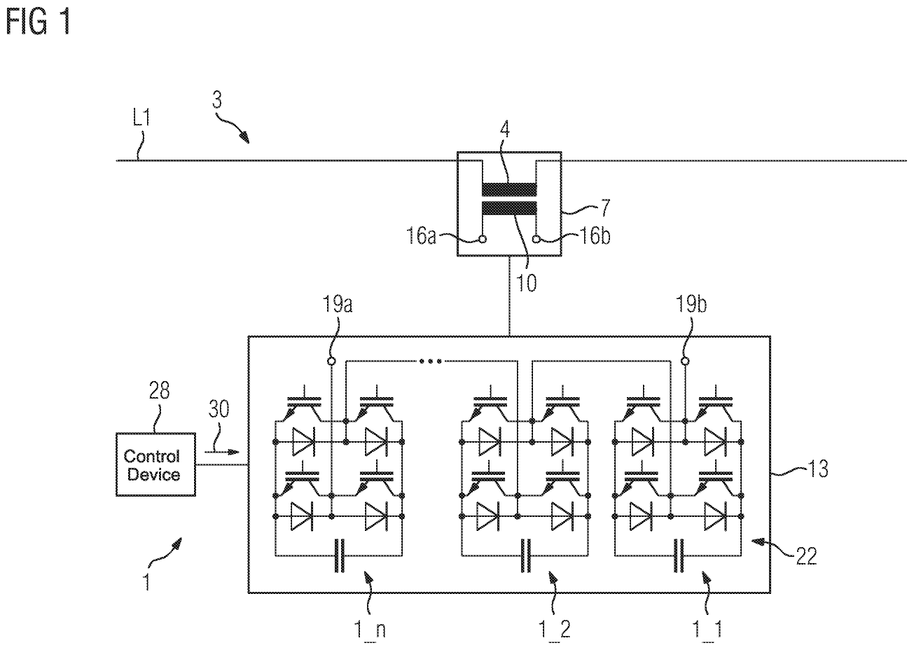

FIG. 1 represents an exemplary embodiment of a series compensation device having a modular multi-level power converter,

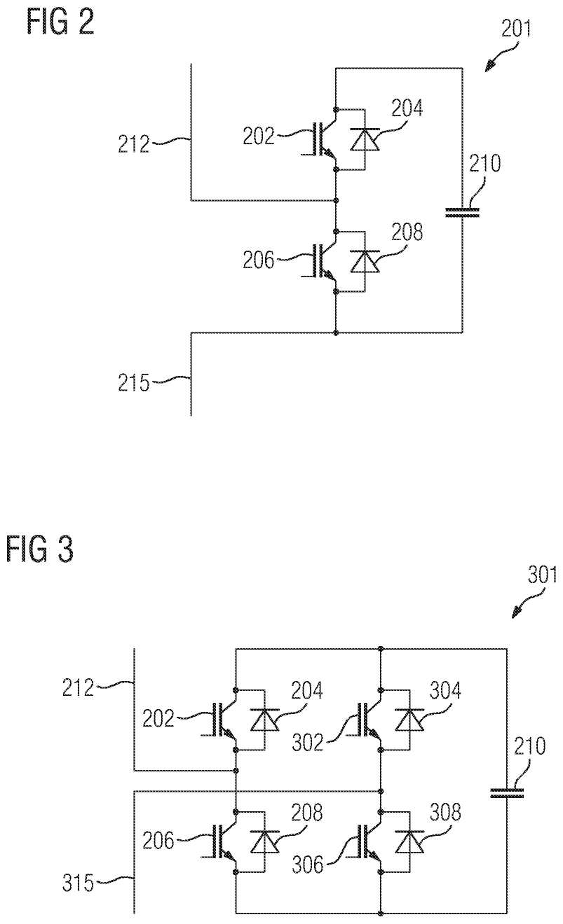

FIG. 2 represents an exemplary embodiment of a module of the modular multi-level power converter,

FIG. 3 represents a further exemplary embodiment of a module of the modular multi-level power converter,

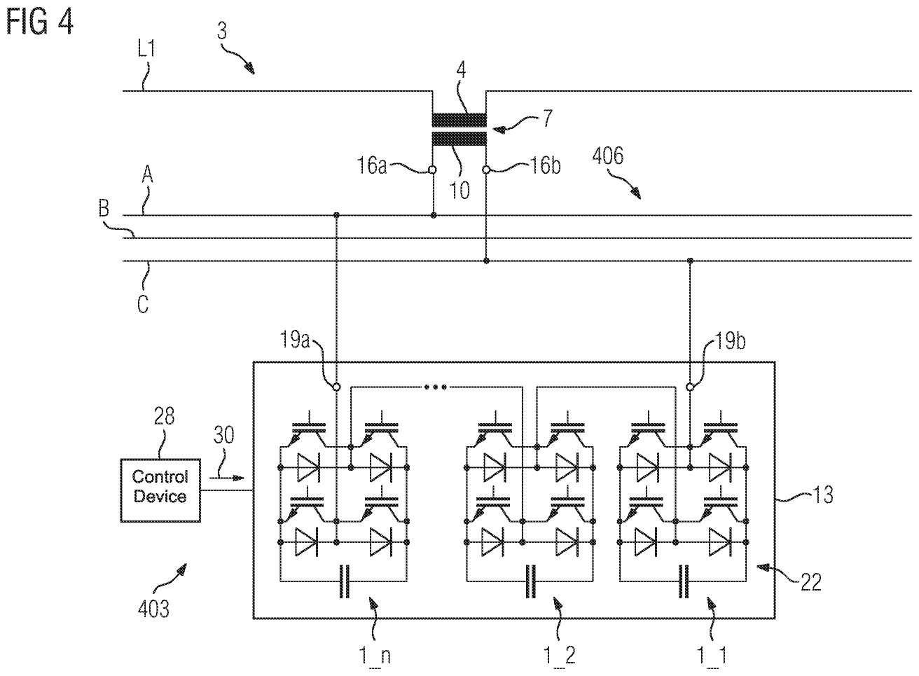

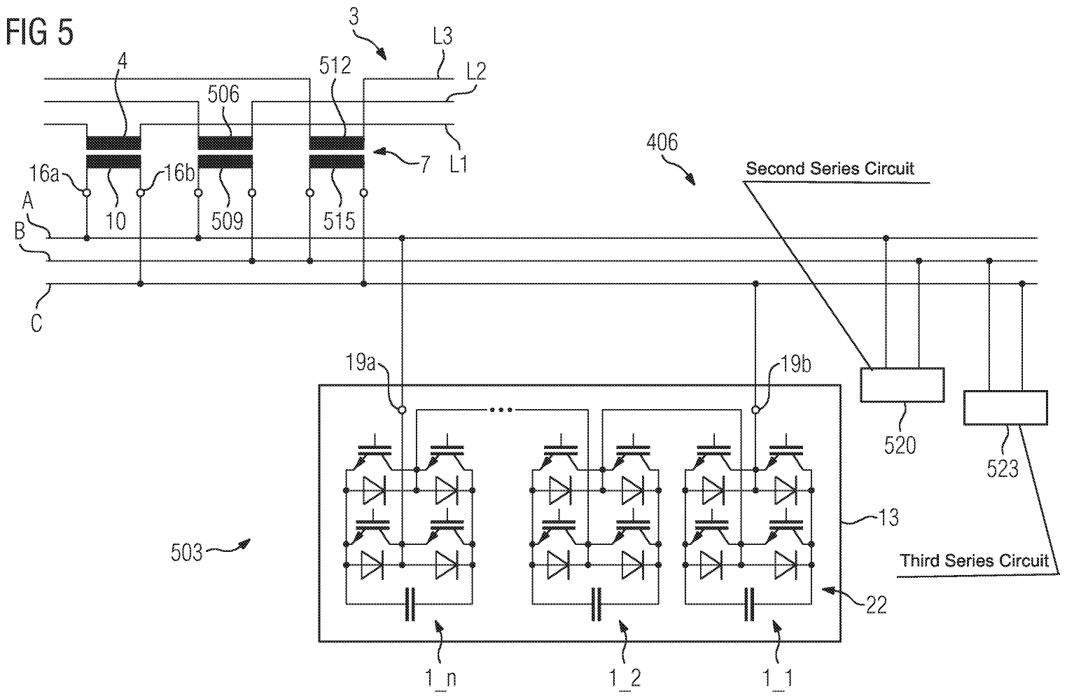

FIG. 4 represents an exemplary embodiment of a series compensation device for a phase line of an energy transmission network,

FIG. 5 represents an exemplary embodiment of a series compensation device for three phase lines of the energy transmission network,

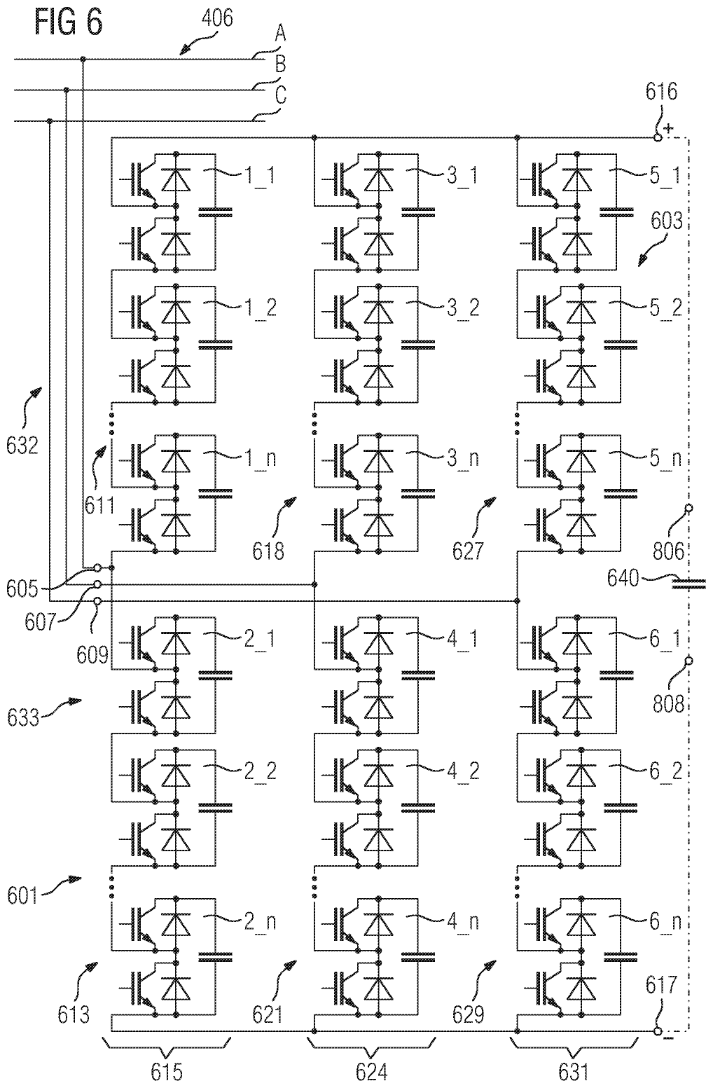

FIG. 6 represents an exemplary embodiment of part of a series compensation device having a multi-level power converter with half-bridge sub-modules,

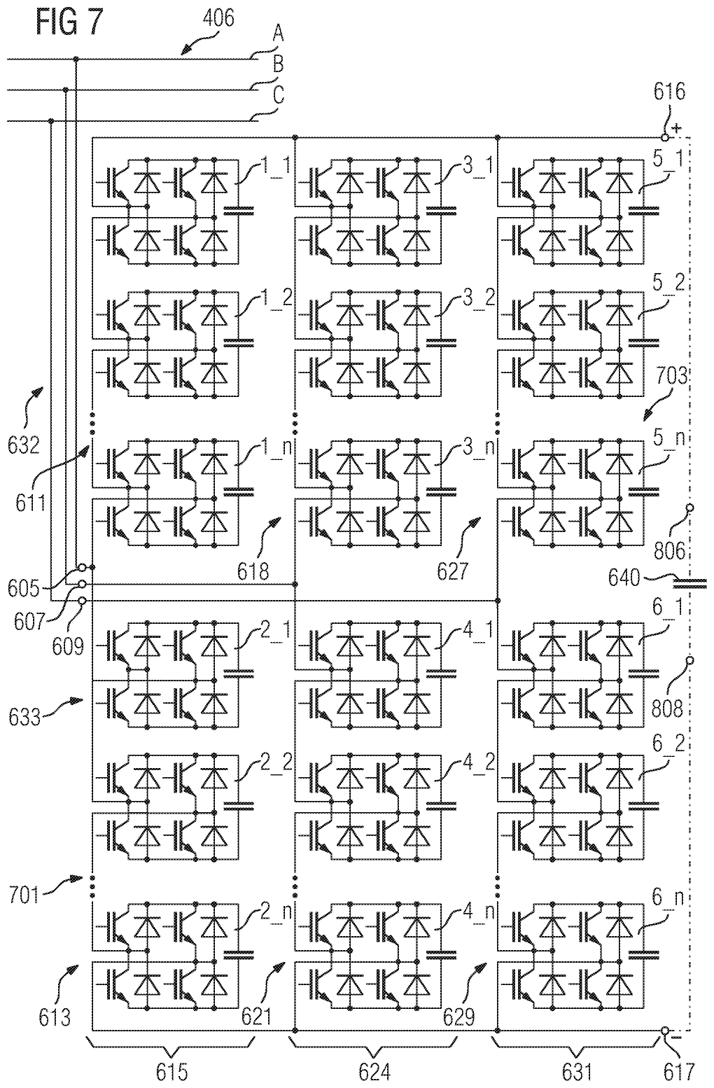

FIG. 7 represents an exemplary embodiment of part of a series compensation device having a multi-level power converter with full-bridge sub-modules,

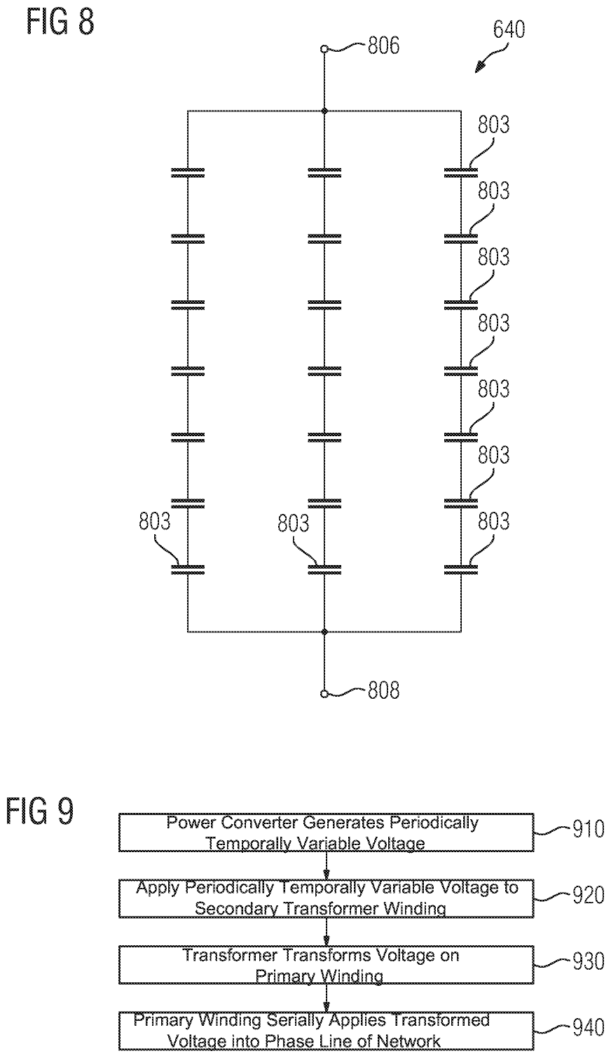

FIG. 8 represents an exemplary embodiment of an energy store on the DC voltage-side terminal of the modular multi-level power converter, and

FIG. 9 represents an exemplary sequence of a series compensation method for an electrical energy transmission network

An exemplary embodiment of a series compensation device 1 is represented in FIG. 1. An energy transmission network 3 comprises a first phase line L1. The present case involves an AC energy transmission network 3. In the first phase line L1, a primary winding 4 of a transformer 7 is connectable or connected in series. In the exemplary embodiment, the energy transmission network is a high-voltage energy transmission network, and the first phase line L1 is a first high-voltage phase line L1. Correspondingly, the transformer 7 is a high-voltage transformer 7. A secondary winding 10 of the transformer 7 is electrically connected to a modular multi-level power converter 13. More specifically, two secondary winding terminals 16a and 16b are electrically connected to two AC voltage terminals 19a and 19b of the modular multi-level power converter 13. The modular multi-level power converter 13 comprises a series circuit 22 of modules 1_1, 1_2, . . . 1 n. The series circuit of modules 1 1 to 1 n extends between the two AC voltage terminals 19a and 19b of the modular multi-level power converter 13. In the exemplary embodiment according to FIG. 1, the modules 1_1 to 1_n are configured as full-bridge modules. In another exemplary embodiment, however, the modules might also be half-bridge modules.

A control device 28 is further represented, which actuates the modules 1_1 to 1_n. Thereafter, on the AC voltage terminals 19a and 19b of the series circuit 22, a periodically temporally variable voltage is generated, which is applied to the secondary winding 10 of the transformer 7. The transformer 7 transforms said periodically temporally variable voltage on the primary winding 4. The primary winding 4 applies this transformed voltage to the first phase line L1 of the energy transmission network 3 (the transformed voltage is injected into the first phase line L1 of the energy transmission network 3). As a result, a series compensation of the energy transmission network is executed. An effect can thus be achieved which is equivalent to that associated with the connection of a capacitor or an inductance to the energy transmission network 3.

The control device 28 transmits control signals 30 to the modular multi-level power converter. These control signals 30 are fed to the individual modules 1_1 to 1_n of the multi-level power converter, and actuate electronic switching elements of the modules. For example, the control device 28 can transmit a target value to each of the individual modules for the magnitude of the output voltage which is to be delivered by the respective module. Accordingly, by means of the series circuit 22 of modules, virtually any desired voltage can be generated, which is to be delivered as an output on the AC voltage terminals 19a and 19b of the series circuit 22.

FIG. 2 represents an exemplary layout of a module 201. This can be, for example, the module 1_1 of the modular multi-level power converter 13 (or one of the other modules represented in FIG. 1).

The module is configured as a half-bridge module 201. The module 201 comprises a first closable and interruptible electronic switching element 202 (first electronic switching element 202) having a first antiparallel-connected diode 204 (first freewheeling diode 204). The module 201 further comprises a second closable and interruptible electronic switching element 206 (second electronic switching element 206) having a second antiparallel-connected diode 208 (second freewheeling diode 208) and an electrical module energy store 210 in the form of an electrical capacitor 210. The first electronic switching element 202 and the second electronic switching element 206 are respectively configured as an IGBT (insulated-gate bipolar transistor). (In another exemplary embodiment, however, the electronic switching elements might also be configured, for example, as GTOs (gate turn-off thyristors) or as IGCTs (integrated gate-commutated thyristors.) The first electronic switching element 202 is electrically connected in series with the second electronic switching element 206. At the connection point between the two electronic switching elements 202 and 206, a first (galvanic) module terminal 212 is arranged. On the terminal of the second switching element 206 which is arranged opposite the connection point, a second (galvanic) module terminal 215 is arranged. The second module terminal 215 is further connected to a first terminal of the module energy store 210; a second terminal of the module energy store 210 is electrically connected to the terminal of the first switching element 202 which is arranged opposite the connection point.

The module energy store 210 is thus electrically connected in parallel with the series circuit comprised of the first switching element 202 and the second switching element 206. By the corresponding actuation of the first switching element 202 and the second switching element 206, it can be achieved that either the voltage of the module energy store 210 is delivered as an output between the first module terminal 212 and the second module terminal 215, or no voltage output is delivered (i.e. a zero voltage output). By the interaction of modules in the individual module series circuit, the respectively desired output voltage of the power converter can thus be generated. In the exemplary embodiment, actuation of the first switching element 202 and of the second switching element 206 is executed by means of the above-mentioned control signals 30 of the control device 28.

A further exemplary embodiment of a module 301 of the modular multi-level power converter is represented in FIG. 3. This module 301 can be, for example, the module 1_1 (or, alternatively, one of the other modules represented in FIG. 1). In addition to the first electronic switching element 202, the second electronic switching element 206, the first freewheeling diode 204, the second freewheeling diode 208 and the module energy store 210, which are already known from FIG. 2, the module 301 represented in FIG. 3 comprises a third electronic switching element 302 having a third antiparallel-connected freewheeling diode 304, and a fourth electronic switching element 306 having a fourth antiparallel-connected freewheeling diode 308. The third electronic switching element 302 and the fourth electronic switching element 306 are respectively configured as an IGBT (in another exemplary embodiment, however, the electronic switching elements might also be configured, for example, as a GTO or an IGCT). By way of distinction from the circuit according to FIG. 2, the second module terminal 315 is not electrically connected to the second electronic switching element 206, but to a mid-point of an electrical series circuit comprised of the third electronic switching element 302 and the fourth electronic switching element 306.

The module 301 according to FIG. 3 is configured as a “full-bridge module” 301. This full-bridge module 301 is characterized in that, by the corresponding actuation of the four electronic switching elements between the first module terminal 212 and the second module terminal 315, optionally, either the positive voltage of the module energy store 210, the negative voltage of the module energy store 210, or a voltage with the zero value (zero voltage) can be delivered as an output. Accordingly, by means of the full-bridge module 301, the polarity of the output voltage can thus be reversed. The power converter 13 can comprise either only half-bridge modules 201, only full-bridge modules 301, or both half-bridge modules 201 and full-bridge modules 301.

A further exemplary embodiment of a series compensation device 403 is represented in FIG. 4. This series compensation device 403 comprises a three-phase connection system 406, which is electrically connected to the secondary winding 10 of the transformer 7. The connection system 406 comprises a first connection line A, a second connection line B and a third connection line C. The first connection line A, the second connection line B and/or the third connection line C can be, for example, conductor rails or busbars, specifically medium-voltage conductor rails or medium-voltage busbars.

The first secondary winding terminal 16a of the secondary winding 10 is electrically connected to the first connection line A, and the second secondary winding terminal 16b of the secondary winding 10 is electrically connected to the third connection line C. As only the first phase line L1 of the energy transmission network 3 is represented in FIG. 4, the second connection line B remains unused.

The first connection line A is electrically connected to the first AC voltage terminal 19a of the modular multi-level power converter 13; the third connection line C is electrically connected to the second AC voltage terminal 19b of the modular multi-level power converter 13. Accordingly, the first secondary winding terminal 16a of the secondary winding 10 is connected to the first AC voltage terminal 19a of the multi-level power converter 13; the second secondary winding terminal 16b of the transformer 7 is electrically connected to the second AC voltage terminal 19b of the multi-level power converter 13. As a result, the modular multi-level power converter 13 can inject the voltage generated on the AC voltage terminals 19a and 19b thereof into the secondary winding 10 of the transformer 7. The voltage generated by the modular multi-level power converter 13 is thus applied to the secondary winding 10.

In other words, by means of the series compensation device 403, a controllable voltage source is connected in-circuit in the phase line L1. The primary winding 4 of the transformer 7 is connected in-circuit in the first phase line L1. The secondary winding 10 of the transformer 7 (i.e. specifically the secondary winding terminals 16a and 16b) is connected to the multi-level power converter. The primary winding 4 is thus specifically a high-voltage winding 4; the secondary winding 10 is specifically a medium-voltage winding 10.

An exemplary embodiment of a three-phase series compensation device 503 is represented in FIG. 5. This series compensation device 503 constitutes an extension of the single-phase series compensation device 403 represented in FIG. 4 to three phases.

In the exemplary embodiment according to FIG. 5, the energy transmission network 3, in addition to the first phase line L1, also comprises a second phase line L2 and a third phase line L3. The transformer 7, in addition to the first primary winding 4 and the first secondary winding 10, further comprises a second primary winding 506, a second secondary winding 509, a third primary winding 512 and a third secondary winding 515. The second phase line L2 is coupled by means of the second primary winding 506 and the second secondary winding 509 to the first connection line A and the second connection line B. The third phase line L3 is coupled by means of the third primary winding 512 and the third secondary winding 515 to the second connection line B and the third connection line C. In the exemplary embodiment according to FIG. 5, the secondary windings 10, 509 and 515 of the transformer 7 are connected in a delta-connected circuit. In another exemplary embodiment, however, the secondary windings of the transformer 7 might also be connected in another arrangement, for example in a star-connected circuit.

As in the exemplary embodiment according to FIG. 4, the first connection line A and the third connection line C are electrically connected to the first series circuit 22 of modules of the multi-level power converter. The first connection line A and the second connection line B are moreover electrically connected to a second series circuit 520 of modules of the multi-level power converter. The second connection line B and the third connection line C are electrically connected to a third series circuit 523 of modules of the multi-level power converter. Thus, in the exemplary embodiment, the sole function of the first connection line A, the second connection line B and the third connection line C is the connection of the secondary windings (secondary coils) of the transformer 7 to the AC voltage terminals of the multi-level power converter.

In the exemplary embodiment, the first series circuit 22, the second series circuit 520 and the third series circuit 523 are configured with an identical layout; specifically, they each comprise the same number of modules. The three series circuits thus constitute identical converter phases (phase modules). In the exemplary embodiment, the three module series circuits 22, 520 and 523 are arranged in a delta-connected circuit. In other exemplary embodiments, however, these series circuits might also be configured in a different arrangement, for example in a star-connected circuit.

FIG. 6 shows an exemplary representation of part of a further series compensation device 601. Only the three connection lines A, B and C of this series compensation device 601, together with the modular multi-level power converter 603, are represented. The three connection lines A, B and C, in a similar manner to FIG. 5, are electrically connected to the three phase lines L1, L2 and L3 of the energy transmission network 3 via a transformer.

The multi-level power converter 603 comprises a first AC voltage terminal 605, a second AC voltage terminal 607 and a third AC voltage terminal 609. The first AC voltage terminal 605 is electrically connected to the first connection line A; the second AC voltage terminal 607 is electrically connected to the second connection line B, and the third AC voltage terminal 609 is electrically connected to the third connection line C.

The first AC voltage terminal 605 is electrically connected to a first phase module branch 611 and a second phase module branch 613. The first phase module branch 611 and the second phase module branch 613 constitute a first phase module 615 of the power converter 603. The end of the first phase module branch 611 which is averted from the first AC voltage terminal 605 is electrically connected to a first DC voltage terminal 616; the end of the second phase module branch 613 which is averted from the first AC voltage terminal 605 is electrically connected to a second DC voltage terminal 617. The first DC voltage terminal 616 is a positive DC voltage terminal; the second DC voltage terminal 617 is a negative DC voltage terminal.

The second AC voltage terminal 607 is electrically connected to one end of a third phase module branch 618 and to one end of a fourth phase module branch 621. The third phase module branch 618 and the fourth phase module branch 621 constitute a second phase module 624. The third AC voltage terminal 609 is electrically connected to one end of a fifth phase module branch 627 and to one end of a sixth phase module branch 629. The fifth phase module branch 627 and the sixth phase module branch 629 constitute a third phase module 631.

The end of the third phase module branch 618 which is averted from the second AC voltage terminal 607 and the end of the fifth phase module branch 627 which is averted from the third AC voltage terminal 609 are electrically connected to the first DC voltage terminal 616. The end of the fourth phase module branch 621 which is averted from the second AC voltage terminal 607 and the end of the sixth phase module branch 629 which is averted from the third AC voltage terminal 609 are electrically connected to the second DC voltage terminal 617. The first phase module branch 611, the third phase module branch 618 and the fifth phase module branch 627 constitute a positive-side power converter section 632; the second phase module branch 613, the fourth phase module branch 621 and the sixth phase module branch 629 constitute a negative-side power converter section 633.

Each phase module branch comprises a plurality of modules (1_1, 1_2, . . . 1_n; 2_1 . . . 2_n, etc.) which are electrically connected in series (by means of their current terminals). Each phase module branch is thus an electrical module series circuit. The modules are also described as sub-modules. In the exemplary embodiment according to FIG. 6, each phase module branch comprises n modules. The number of the modules which are electrically connected in series by means of their current terminals can vary substantially; although at least two modules are connected in series, it is also possible, for example, for 3, 50, 100 or more modules to be electrically connected in series. In the exemplary embodiment, n=36: the first phase module branch 611 thus comprises 36 modules 1_1, 1_2, 1_3, . . . 1_36. The other phase module branches 613, 618, 621, 627 and 629 are configured to an identical layout.

The modules 1_1 to 6_n of the multi-level power converter 603 are configured as half-bridge modules. In the exemplary embodiment, the six phase module branches constitute a three-phase bridge circuit. A bridge circuit of this type is also described as a double-star-connected circuit. In the exemplary embodiment, the first DC voltage terminal 616 and the second DC voltage terminal 617 can remain unused. However, the first DC voltage terminal 616 and the second DC voltage terminal 617 can also be electrically connected to an energy store 640, which can supply the multi-level power converter with electrical energy, when required. This optional energy store 640 is represented in FIG. 6 by a broken line. Between the first DC voltage terminal 616 and the second DC voltage terminal 617, a DC voltage Ud is present, which is delivered by the energy store 640. By means of the modular multi-level power converter, the energy store 640 permits an injection of active power into the energy transmission network (and not only an injection of reactive power).

FIG. 7 shows an exemplary representation of part of a further series compensation device 701. This series compensation device 701 is only distinguished from the series compensation device 701 represented in FIG. 6 in that the multi-level power converter 703 comprises full-bridge modules (rather than half-bridge modules, as in FIG. 6). Otherwise, the series compensation device 701 is configured to an identical layout.

In FIG. 8, an exemplary embodiment of the optional energy store 640 is represented in greater detail. The energy store 640 comprises a plurality of mutually connected energy storage units 803. In the exemplary embodiment, these energy storage units 803 are electrically connected in series to constitute energy storage unit series circuits. Three such energy storage unit series circuits are connected in parallel, and constitute the energy store 640. The energy storage unit series circuits are each electrically connected to a positive energy store terminal 806 and to a negative energy store terminal 808.

The schematic representation according to FIG. 8 is to be understood as exemplary only. Naturally, in other energy stores, different numbers of energy storage units 803 can be connected in series or in parallel. By the series connection of energy storage units to constitute energy storage unit series circuits, it is possible to deliver high voltages by means of the energy store 640. By the parallel connection of the three energy storage unit series circuits, it is possible to deliver high currents by means of the energy store 640. In principle, the energy storage units 803 can comprise any electrical energy storage units, specifically capacitors or batteries. By way of capacitors, “super capacitors” (supercaps) can specifically be employed.

FIG. 9 represents the exemplary sequence of a series compensation method for an electrical energy transmission network 3. The sequence of process steps executed is therefore as follows:

Process step 910: a periodically temporally variable voltage is generated by the modular multi-level power converter 13.

Process step 920: the periodically temporally variable voltage is applied to the secondary winding 10 of the transformer 7.

Process step 930: the transformer 7 transforms said voltage on a primary winding 4.

Process step 940: by means of the primary winding 4, the transformed voltage is serially applied to/injected into the phase line L1 of the energy transmission network 3.

By means of the series compensation device described, long phase lines of energy transmission networks can be advantageously compensated for. By means of the series compensation device comprising the multi-level power converter (by way of distinction from a thyristor controlled series capacitor, or TCSC), operation is possible in a virtually fully-inductive impedance range. As a result, specifically, load flux control in the energy transmission network is permitted over an extensive capacity range. Additionally, by means of the series compensation device, it is possible to execute a damping of unwanted oscillations in the energy transmission network (sub-synchronous resonances, or SSR). Moreover, it is advantageously possible to execute “power oscillation dumping” (POD) in the energy transmission network, by means of the series compensation device. By way of distinction from the connection of individual passive capacitor components to the energy transmission network, the series compensation device described prevents the inducement of points of resonance in the network, and thus the generation of unwanted SSR. Additionally, the series compensation device can even damp SSRs which have been generated by other series capacitors which are connected to the network. SSR damping of this type is frequently required, and thus constitutes a particularly advantageous property of the series compensation device.

By means of the modular multi-level power converter, advantageously virtually any voltage characteristics desired can be generated and applied to the energy transmission network 3 via the transformer. Theoretically, it would also be possible, in place of the multi-level power converter, to employ three-level power converters, and to connect a plurality of said three-level power converters in series. Although a greater number of stages (number of levels) would be achieved as a result, this concept reaches its limitations at a high number of levels (stages). Moreover, in a series circuit of three-level power converters of this type, the design would not be linear, as the number of diodes of the three-level power converters in the series circuit is dependent upon the number of levels in the overall series circuit. This means that, rather than incorporating any universally employable modules, this design would require the series connection of specially-designed three-level power converters in each case, depending upon requirements. Moreover, in this concept, an increase in the number of levels would result in an increase in the number of capacitors in the intermediate DC voltage circuit of the three-level power converters. Actuation and energy balancing would also be extraordinarily complicated. This problem is avoided by the employment of a modular multi-level power converter in the series compensation device.

A series compensation device and a series compensation method have been described, which can be flexibly adapted to different requirements, and by means of which energy transmission networks can be series compensated in a flexible and cost-effective manner.

1-10. (canceled)

11. A series compensation device for an electrical energy transmission network, the series compensation device comprising:
a transformer having a primary winding and a secondary winding;
said primary winding of said transformer configured to be connected in series in a phase line of the energy transmission network; and
a modular multi-level power converter including a multiplicity of modules forming an electrical module series circuit, said modular multi-level power converter being connected to said secondary winding of said transformer.

12. The series compensation device according to claim 11, wherein said electrical module series circuit is one of three module series circuits of said modular multi-level power converter, said three module series circuits forming a delta-connected circuit.

13. The series compensation device according to claim 11, wherein said electrical module series circuit is one of six module series circuits of said modular multi-level power converter, said six module series circuits forming a bridge circuit.

14. The series compensation device according to claim 11, wherein each of said modules includes at least two respective electronic switching elements and one respective electrical module energy store.

15. The series compensation device according to claim 14, wherein:
said two electronic switching elements of said modules are disposed in a half-bridge circuit, or
said modules each include said two respective electronic switching elements and two respective further electronic switching elements, said two electronic switching elements and said two further electronic switching elements being disposed in a full-bridge circuit.

16. The series compensation device according to claim 11, which further comprises an energy store connected to said modular multi-level power converter.

17. The series compensation device according to claim 16, wherein said energy store includes a plurality of mutually connected energy storage units.

18. The series compensation device according to claim 17, wherein said energy storage units are at least one of capacitors or batteries.

19. The series compensation device according to claim 11, which further comprises a control device actuating said multi-level power converter for causing said multi-level power converter to generate a periodically temporally variable voltage.

20. A series compensation method for an electrical energy transmission network, the method comprising the following steps:
using a modular multi-level power converter to generate a periodically temporally variable voltage;
applying the voltage to a secondary winding of a transformer;
using the transformer to transform the voltage on a primary winding of the transformer; and
using the primary winding to serially inject a transformed voltage into a phase line of the energy transmission network.
